(19) United States
(12) Patent Application Publication
(10) Pub. No.: US 2023/0313758 A1
(43) Pub. Date: Oct. 5, 2023

(54) FEED SYSTEM FOR ROCKET ENGINE

(71) Applicant: Atlantis Research Labs Inc., Medicine Hat (CA)

(72) Inventor: Troy Leonard Messinger, Medicine Hat (CA)

(21) Appl. No.: 18/192,875

(22) Filed: Mar. 30, 2023

Related U.S. Application Data
(60) Provisional application No. 63/325,994, filed on Mar. 31, 2022.

(51) Int. Cl. F02K 9/48; F02K 9/64

(52) U.S. Cl. CPC F02K 9/48; F02K 9/64

(57) ABSTRACT

The present invention relates to a propellant feed system for a rocket engine including a jet pump including a motive inlet for receiving a gaseous propellant, a driven inlet for receiving a liquid propellant, and an outlet for ejecting a mixed stream of the gaseous propellant and the liquid propellant. The propellant feed system further includes a heat exchanger configured to transfer thermal energy from a combustion chamber to the liquid propellant or the mixed stream, thereby transforming the liquid propellant or the mixed stream into the gaseous propellant. The propellant feed system further includes a pump configured to pump the liquid propellant or the mixed stream into the heat exchanger.

### CROSS REFERENCE TO RELATED APPLICATIONS

This application claims the benefit of priority to U.S. provisional patent application Ser. No. 63/325,994 entitled “FEED SYSTEM FOR ROCKET ENGINE” filed Mar. 31, 2022, hereby incorporated by reference in its entirety.

### FIELD OF THE INVENTION

The present invention pertains in general to the field of rocket engines. More particularly, the invention relates to a propellant feed system comprising at least one jet pump.

### BACKGROUND OF THE INVENTION

Liquid rocket engines having two propellants stored in liquid state are called liquid bipropellant rocket engines. A liquid bipropellant rocket engine typically has an oxidizer as one propellant and a fuel as the second propellant. Both propellants are injected into a combustion chamber where they combust, resulting in propulsion.

Hybrid rocket engines typically have one propellant stored in liquid state and the second propellant stored in solid state. One propellant is typically an oxidizer (most commonly the liquid propellant), and the other propellant is typically a fuel (most commonly the solid propellant). The liquid propellant is injected into a combustion chamber containing the solid propellant, where the two propellants combust, resulting in propulsion.

Monopropellant rocket engines typically have a single propellant in liquid state.

Rocket combustion chambers are fed propellants through a variety of methods. In a pump-fed method, at least one pump is used to inject the liquid propellant into the high-pressure combustion chamber. Rocket engines typically utilize turbopumps which are associated with high cost, complex manufacturing and operation, poor scalability for applications where smaller dimensions or weight are preferred, and requirement of using dynamic seals. As an alternative, battery-powered electric motors have been utilized to replace the turbine of the turbopump, but such application in rocket engines is limited by typically high mass associated with electric batteries.

Therefore, there is a need for an improved propellant feed system for hybrid, monopropellant and bipropellant rocket engines that obviates or mitigates one or more deficiencies of the prior art.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

The present invention relates to an apparatus and method for operating a propellant feed system configuration for a rocket engine including at least one jet pump to deliver a propellant to a chamber containing the combustion reaction resulting in rocket propulsion. A heat exchanger may be used to transfer some of the thermal energy generated by the combustion reaction from the combustion chamber to a propellant stream. The thermal energy may transform the stream into a gaseous propellant used in operating the jet pump.

In accordance with an embodiment of the present disclosure, there is provided an apparatus and a method for operating a propellant feed system for a rocket engine including a jet pump including a motive inlet for receiving a gaseous propellant, a driven inlet for receiving a liquid propellant, and an outlet for ejecting a mixed stream of the gaseous propellant and the liquid propellant; a heat exchanger configured to transfer thermal energy from a combustion chamber to the liquid propellant or the mixed stream, thereby transforming the liquid propellant or the mixed stream into the gaseous propellant; and a pump configured to pump the liquid propellant or the mixed stream into the heat exchanger, wherein the combustion chamber receives the mixed stream from the jet pump outlet.

In accordance with an embodiment of the present disclosure, there is further provided a reservoir storing the liquid propellant, an outlet of the reservoir providing the liquid propellant to the jet pump. There is further provided a pressurant reservoir storing a pressure gas to apply pressure to the reservoir. The pressure gas may include the gaseous propellant, the gaseous propellant being received from the heat exchanger.

In accordance with an embodiment of the present disclosure, there is further provided a plurality of jet pumps connected in series, a plurality of jet pumps connected in parallel, or a plurality of jet pumps connected in both series and parallel.

In accordance with an embodiment of the present disclosure, the combustion chamber further includes a solid propellant, wherein the mixed stream is combusted within the combustion chamber with the solid propellant contained in the combustion chamber.

In accordance with an embodiment of the present disclosure, there is provided an apparatus and a method for operating a propellant feed system for a rocket engine, wherein the combustion chamber further includes a propellant source for receiving a second propellant, the second propellant and the mixed stream being combusted within the combustion chamber, wherein the propellant source includes: a second jet pump including a second motive inlet for receiving a second gaseous propellant, a second driven inlet for receiving a second liquid propellant, and a second outlet for ejecting a second mixed stream of the second gaseous propellant and the second liquid propellant; a second heat exchanger configured to transfer thermal energy from the combustion chamber to the second liquid propellant or the second mixed stream, thereby transforming the second liquid propellant or the second mixed stream into the second gaseous propellant; and a second pump configured to pump the second liquid propellant or the second mixed stream into the second heat exchanger.

In accordance with an embodiment of the present disclosure, there is provided a method for starting up the operation of a propellant feed system for a rocket engine including supplying a quantity of a gas to the jet pump; supplying a second quantity of the gas to the pump; wherein the quantity of the gas and the second quantity of the gas is sufficient in amount to result in steady state operation of the propellant feed system.

### BRIEF DESCRIPTION OF THE FIGURES

Further features and advantages of the propellant feed system of the present disclosure will become apparent from the following detailed description, taken in combination with the appended figures, in which:

FIG. 1 is a schematic cross-sectional view of a jet pump, in accordance with an embodiment of the present invention.

FIG. 2 is a schematic illustration of the propellant feed system, in accordance with an embodiment of the present disclosure.

FIG. 3 is a schematic illustration of the propellant feed system, in accordance with another embodiment of the present disclosure.

FIG. 4 is a schematic illustration of the propellant feed system for a bipropellant rocket, in accordance with an embodiment of the present disclosure.

FIG. 5 is a schematic illustration of the propellant feed system for a bipropellant rocket, in accordance with another embodiment of the present disclosure.

FIG. 6 is a flow chart illustrating main steps of operating the propellant feed system, in accordance with various embodiments of the present disclosure.

FIG. 7 is a flow chart illustrating main steps of starting up the propellant feed system, in accordance with various embodiments of the present disclosure.

FIG. 8 is a flow chart illustrating example operational steps of starting up and operating the propellant feed system for a hybrid rocket, in accordance with an embodiment of the present disclosure.

FIG. 9 is a flow chart illustrating example operational steps of starting up and operating the propellant feed system for a bipropellant rocket, in accordance with an embodiment of the present disclosure.

It will be noted that throughout the appended drawings, like features are identified by like reference numerals.

### DETAILED DESCRIPTION

Unless defined otherwise, all technical and scientific terms used herein have the same meaning as commonly understood by one of ordinary skill in the art to which this invention belongs. The boldface numbers correspond to the component labels in all the figures.

In embodiments, a propellant feed system configuration for a rocket engine including at least one jet pump is described here by its most fundamental elements. The jet pump is used to deliver a propellant to a chamber containing the combustion reaction resulting in rocket propulsion. A heat exchanger may be used to transfer some of the thermal energy generated by the combustion reaction from the combustion chamber to a stream. The thermal energy may transform the stream into a gaseous propellant used in operating the jet pump.

A jet pump (known as ejector pump, eductor pump, injector, or venturi) is a pumping device that utilizes the transfer of momentum and energy from a higher-pressure flow to a lower-pressure flow. When the higher-pressure, higher-velocity flow combines with the lower-pressure flow within the jet pump, the overall pressure of the starting lower-pressure flow is increased through transfer of energy from the higher-pressure flow to the lower-pressure flow.

In embodiments, a higher-pressure flow entering the jet pump is referred to as the gaseous propellant or the motive fluid.

In embodiments, a lower-pressure flow entering the jet pump is referred to as the liquid propellant or the secondary fluid.

In embodiments, the liquid propellant and the gaseous propellant may be the same propellant in liquid state and gaseous state.

In embodiments, the combination of a higher-pressure flow and a lower-pressure flow exiting the jet pump is referred to as the mixed stream.

In embodiments, a gaseous propellant may be formed as a result of a liquid propellant or a mixed stream receiving thermal energy from a combustion chamber containing the combustion reaction. At least one heat exchanger may be used to facilitate such energy transfer.

In embodiments, a device, such as a pump, may be used to facilitate delivery of a flow (the liquid propellant, the mixed stream, or combinations thereof) to the heat exchanger. Non-limiting examples of the pump for various embodiments of the present disclosure include a positive displacement pump (e.g., piston, plunger, diaphragm, rotor, scroll compressor), a centrifugal pump (e.g., axial, peripheral, mixed flow), a gear pump, another jet pump, or another device with similar functionality as understood by a person skilled in the art. The pump may be driven by a battery-powered electric motor, for example.

In embodiments, the combustion chamber contains the reaction that results in propulsion. The combustion chamber accepts at least one injected propellant. The combustion chamber may store a propellant in solid state. The combustion chamber may include a nozzle. The combustion chamber may accelerate the combustion products through the connected nozzle. The combustion chamber may include other elements (e.g. ignition source, sensors, gauges), as understood by a person skilled in the art.

In embodiments, the combustion chamber may receive only one propellant which undergoes a reaction, resulting in propulsion. In such monopropellant rocket engine embodiments, the propellant can flow through a catalyst or otherwise interact with a catalyst before it reaches the combustion chamber or as it enters the combustion chamber.

In embodiments, some or all components of the propellant feed system may operate cooperatively to feed at least one propellant into the combustion chamber where the reaction occurs, resulting in propulsion.

In embodiments, a liquid propellant may be an oxidizer. Non-limiting examples of the oxidizer propellant for various embodiments of the present disclosure include nitrous oxide, liquid oxygen, nitrogen tetroxide, nitric acid, hydrogen peroxide, and combinations thereof.

In embodiments, a liquid propellant may be a fuel. Non-limiting examples of the fuel propellant include kerosene, methane, ethane, and hydrogen, other liquid hydrocarbon compounds known in the art to be used as fuel, and combinations thereof.

In embodiments, a solid propellant may be a fuel. Non-limiting examples of a solid fuel for use as a hybrid rocket propellant for various embodiments of the present disclosure include polyethylene, poly-methyl methacrylate, poly-vinyl chloride, hydroxyl terminated poly-butadiene, paraffin wax, other polymeric compounds known in the art to be used as solid fuel, and combinations thereof.

In embodiments, a gaseous propellant may be the liquid propellant in gaseous state having at least one of the following: a higher pressure, a higher temperature, or a higher velocity than the liquid propellant. In some embodiments, the liquid propellant (e.g., nitrous oxide, hydrogen peroxide) may decompose into its chemical constituents as a result of coming in contact with a catalyst.

In embodiments, a single propellant may be used in a monopropellant rocket engine. A catalyst may be used to facilitate a chemical reaction of the propellant. Non-limiting examples of the propellant include hydrazine, hydrogen peroxide, propyl nitrate, other compounds known in the art to be used as a propellant in monopropellant rocket engine, and combinations thereof.

In embodiments, some or all components and connections of the propellant feed system of the present disclosure may include one or more devices. Such devices may include a sensor, a gauge, a throttle, a valve, and a control device, as understood by a person skilled in the art, to participate in various actions of the propellant feed system components and connections.

In embodiments, some, or all connections of the propellant feed system of the present disclosure may have as least one parameter participating in at least one action of the propellant feed system. Non limiting examples of such parameters include dimensional parameters, physical parameters, chemical parameters, and geometric parameters, as understood by a person skilled in the art.

Embodiments of the present disclosure relate to apparatus for and method of feeding at least one propellant into a combustion chamber of a rocket engine using at least one jet pump, where the jet pump receives a gaseous propellant from a heat exchanger generated as a result of heat exchange between a part of the propellant and the combustion chamber.

The jet pump includes a motive inlet that receives the gaseous propellant. The jet pump also includes a driven inlet that receives the liquid propellant. The jet pump further includes an outlet for a mixed stream. The mixed stream outlet comprises a relatively high pressure mixture compared to the driven inlet liquid propellant. The mixed stream is comprised of the liquid propellant and the gaseous propellant. Preferably, the mixed stream is in liquid state. Pressure of the jet pump outlet stream is greater than the pressure of the jet pump inlet liquid propellant stream.

The combustion chamber receives the mixed stream from the discharge outlet of the jet pump. The mixed stream may be in communication with one or more devices that may participate in regulating the mixed stream flow into the combustion chamber. One or more such devices may include a sensor, a gauge, a throttle, a valve, an injector, and a control device, as understood by a person skilled in the art.

A reservoir may contain a main quantity of the liquid propellant.

A pump (or another device having similar functionality) may be used to deliver a flow the liquid propellant, the mixed stream or a combination thereof to the heat exchanger and cause the flow to circulate through the heat exchanger. The pump may be driven by a battery-powered electric motor, for example. In various embodiments, the pump may be substituted by multiple pumps in communication with each other in series, in parallel or a combination of series and parallel.

In an embodiment, the inlet of the pump may receive flow from the reservoir storing the liquid propellant. In another embodiment, the inlet of the pump may receive flow from the outlet of the jet pump, the flow comprising the mixed stream of the liquid propellant and the gaseous propellant. In another embodiment, the inlet of the pump may receive some flow from the reservoir storing the liquid propellant and some flow comprising the mixed stream.

The heat exchanger facilitates transfer of thermal energy from the combustion chamber to the flow pumped into the heat exchanger by the pump. As a result, the flow entering the heat exchanger is transformed into a gaseous propellant, which includes mainly a hot propellant vapour.

In an embodiment, a pressurant reservoir may contain a pressurized portion of the gaseous propellant generated via the heat exchanger.

In an embodiment, the pressurant reservoir may, possibly in addition to or alternatively to storing the gaseous propellant, have any one or a combination of the following functionalities: providing pressure for pressurizing the reservoir storing the liquid propellant; supplying an initial quantity of gas (start gas) to start the operation of the propellant feed system; functioning as an accumulator to dampen out pumping oscillations that may be present through the heat exchanger.

In embodiments, the propellant feed system may include, in addition to some or all of the elements and corresponding embodiments discussed herein, a second jet pump, a second liquid propellant, a second gaseous propellant, a second mixed stream, a second heat exchanger, a second pump, a second reservoir, and a second pressurant reservoir.

The second jet pump includes a motive inlet that receives the second gaseous propellant. The second jet pump also includes a driven inlet that receives the second liquid propellant. The second jet pump further includes an outlet for ejecting a second mixed stream. The second mixed stream comprises a relatively high pressure mixture compared to the driven inlet comprising the second liquid propellant. The second mixed stream is comprised of the (second) liquid propellant and the (second) gaseous propellant. Pressure of the second jet pump outlet stream is greater than the pressure of the second jet pump inlet liquid propellant stream. Preferably, the second mixed stream is in liquid state.

The combustion chamber, in addition to receiving the mixed stream, receives the second mixed stream from the discharge outlet of the second jet pump. The second mixed stream may be in communication with one or more devices that may participate in regulating the mixed stream flow into the combustion chamber. One or more such devices may include a sensor, a gauge, a throttle, a valve, an injector, and a control device, as understood by a person skilled in the art.

A second reservoir may contain a main quantity of the second liquid propellant.

A second pump (or another device having similar functionality) may be used to deliver a flow to the second heat exchanger and cause the flow to circulate through the second heat exchanger. The second pump may be driven by a battery-powered electric motor, for example. In various embodiments, the second pump may be substituted by multiple pumps in communication with each other in series, in parallel or a combination of series and parallel.

In an embodiment, the inlet of the second pump may receive flow from the second reservoir storing the second liquid propellant. In another embodiment, the inlet of the second pump may receive flow from the outlet of the second jet pump, the flow comprising the second mixed stream of the second liquid propellant and the second gaseous propellant. In another embodiment, the inlet of the second pump may receive some flow from the second reservoir storing the second liquid propellant and some flow comprising the second mixed stream.

The second heat exchanger is configured to transfer thermal energy from the combustion chamber to a flow pumped into the second heat exchanger by the second pump. As a result, the flow entering the second heat exchanger is transformed into the second gaseous propellant, which includes mainly a hot second propellant vapour.

In an embodiment, a second pressurant reservoir may contain a pressurized portion of the second gaseous propellant generated via the second heat exchanger.

In an embodiment, the second pressurant reservoir may, possibly in addition to or alternatively to storing the second gaseous propellant, have any one or a combination of the following functionalities: providing pressure for pressurizing the second reservoir storing the second liquid propellant; supplying an initial quantity of second gas (start gas) to start the operation of the propellant feed system; functioning as an accumulator to dampen out pumping oscillations that may be present through the second heat exchanger.

In embodiments, the propellant feed system may include multiple jet pumps in communication with each other in series, in parallel or a combination of series and parallel.

In an embodiment, a first group of jet pumps connected in series may also be connected in parallel with a second group of jet pumps connected in series.

In an embodiment, a first group of jet pumps connected in parallel may also be connected in series with a second group of jet pumps connected in parallel.

In an embodiment, at least one additional jet pump may be connected to a first jet pump in series. For example, the discharge outlet of the first jet pump as described in the present disclosure may be in communication with a driven inlet of an additional jet pump, the motive inlet of the additional jet pump receiving a gaseous propellant from the same or separate heat exchanger as the first jet pump. Similarly for embodiments having more than two jet pumps arranged in series, the discharge outlet of the next additional jet pump may be in communication with a driven inlet of the previous jet pump, and so on. As understood by a person skilled in the art, potential advantages of using multiple pumps in series include attaining higher mixed stream pressure compared to a system having a single pump.

In an embodiment, at least one additional jet pump may be connected to a first jet pump in parallel. For example, a liquid propellant source and a gaseous propellant source may be in communication with a driven inlet and a motive inlet, respectively, of the first jet pump and each additional jet pump. A device may be used to separate the liquid propellant flow among all connected jet pumps. Another device may be used to separate gaseous propellant flow among all jet pumps. The discharge flow (mixed stream) of each jet pump may be combined into a single flow. As understood by a person skilled in the art, potential advantages of using multiple pumps in parallel include attaining higher mixed stream flow rate compared to a system having a single pump.

The potential benefits of embodiments of the propellant feed system disclosed herein include at least one of the following: improved performance, reduced structural and/or operational complexity, ease of maintenance, and ease of scalability, particularly for scaling down propellant feed systems, in comparison with existing propellant feed systems.

Use of a lower-pressure propellant as the driven fluid in the jet pump of the propellant feed system disclosed herein allows the propellant storage reservoir to be composed of thinner walls, resulting in reduced reservoir mass. Storing the lower-pressure propellant to be used as the driven fluid in the jet pump in liquid state allows the use of a smaller propellant reservoir, resulting in reduced reservoir mass compared to storing similar quantity of propellant in gaseous state.

A propellant feed system of the present disclosure utilizes at least one jet pump and does not require complex seals that are typically required in conventional turbine pump configurations. The propellant feed system of the present disclosure has potentially lower cost of manufacturing and maintenance having potentially no moving parts, is potentially more lightweight compared to conventional feed systems, and may be readily scalable for rocket engine systems having lower propellant pressure requirements, for example in hybrid rockets, small-lift launch vehicles, and low thrust applications such as in-space propulsion.

To gain a better understanding of the invention described herein, the following examples are set forth with reference to the accompanying simplified, diagrammatic, not-to-scale drawings. It will be understood that these examples are intended to describe illustrative embodiments of the invention and are not intended to limit the scope of the invention in any way.

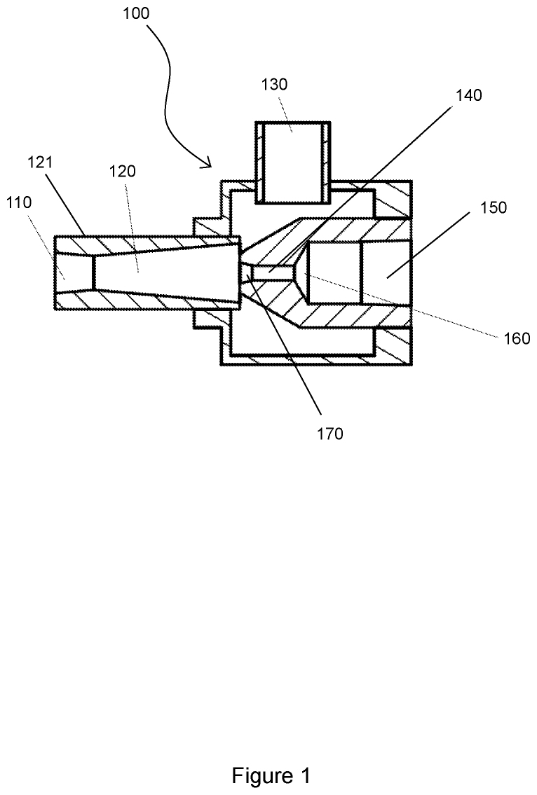

FIG. 1 shows a schematic cross-sectional view of a jet pump 100, according to an embodiment.

The jet pump 100 receives a gaseous propellant (also called motive fluid, motive stream, primary fluid, propellant vapour, working fluid) through a motive inlet 150 (also called primary inlet, vapour inlet, gaseous propellant inlet). The motive inlet 150 may include a converging section 160. The motive inlet 150 may include a diverging section 170. The converging section 160 and the diverging section 170 may be connected by a throat 140. In various embodiments of the present disclosure, the motive inlet 150 of the jet pump 100 preferably has a nozzle (also called primary nozzle) which may include one or both of the converging section 160 and the diverging section 170.

The jet pump 100 receives a liquid propellant (also called entrained fluid, driven fluid, entrained stream, secondary fluid, relatively low pressure liquid propellant) through a driven inlet 130 (also called entrained fluid inlet, secondary inlet, liquid inlet).

The liquid propellant is drawn into the jet pump by the gaseous propellant. As the liquid propellant and the gaseous propellant come in contact with each other inside the jet pump, a transfer of momentum and energy from the relatively high velocity gaseous propellant to the relatively low velocity liquid propellant results in a mixed stream of the gaseous propellant and the liquid propellant, which can be ejected from the jet pump via outlet 121. The mixed stream has a pressure higher than the liquid propellant entering the jet pump. The outlet 121 may include a converging section 120. The outlet 121 may include a diverging section 110.

In various embodiments of the present disclosure, the jet pump outlet 121 preferably includes a converging section 120 and may include a diverging section 110 to contribute to recovering pressure of the mixed stream as it passes through the outlet 121 and exits the jet pump 100.

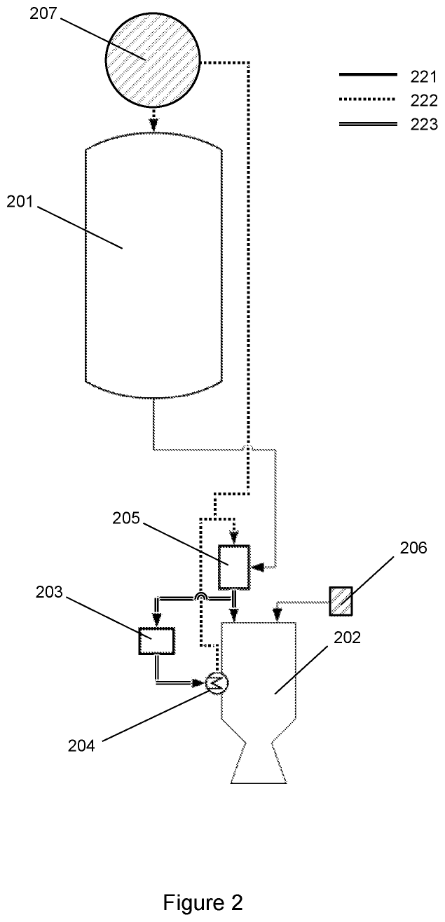

In an embodiment schematically illustrated in FIG. 2, a jet pump 205 receives a liquid propellant through a driven inlet and receives a gaseous propellant through a motive inlet. A mixed stream of the liquid propellant and the gaseous propellant is ejected from the jet pump 205 through an outlet.

The propellant in liquid state may follow a path illustrated in FIG. 2 by a solid line 221. The propellant in gaseous state may follow a path illustrated in FIG. 2 by a dotted line 222. The propellant in mixed stream state may follow a path illustrated in FIG. 2 by a double line 223.

Some of the mixed stream ejected from the jet pump 205 may enter a combustion chamber 202. Some of the mixed stream may enter a pump 203 which pumps the mixed stream into a heat exchanger 204. In another embodiment, the mixed stream ejected from the jet pump 205 may pass through one or more devices that may contribute to regulating the mixed stream flow into the combustion chamber 202 and the pump 203. As understood by a person skilled in the art, such device may function as a flow control valve, variable restriction flow device, or other such flow control device and may make use of one or more sensors, non-limiting examples of sensors may include pressure sensors, temperature sensors, flow sensors, for example for feedback and control of flow.

A reservoir 201 may provide the liquid propellant for the driven inlet of the jet pump 205.

The heat exchanger 204 is configured to transfer thermal energy from the combustion chamber 202 to a stream pumped into the heat exchanger 204 by the pump 203. In an embodiment, the stream may comprise the mixed stream.

The transfer of thermal energy in the heat exchanger 204 transforms the stream (which may include the mixed stream) pumped into the heat exchanger 204 by the pump 203 into the gaseous propellant. Some of the gaseous propellant exiting the heat exchanger 204 is fed into the motive inlet of the jet pump 205.

In an embodiment, some of the gaseous propellant exiting the heat exchanger 204 may be fed into a pressurant reservoir 207. The pressurant reservoir 207 storing the gaseous propellant may be in communication with the reservoir 201 storing the liquid propellant in order to maintain pressure inside the reservoir 201. In addition to or alternatively to maintaining pressure inside the reservoir 201, the pressurant reservoir 207 may function as an accumulator to dampen out pumping oscillations from the heat exchanger 204. In addition to or alternatively to maintaining pressure inside the reservoir 201 or functioning as an accumulator to dampen out pumping oscillations from the heat exchanger 204, the pressurant reservoir 207 may provide a start gas for starting up the propellant feed system.

The pressurant reservoir 207 may include one or more devices (e.g., a pump, a sensor, a gauge, a valve) which contribute to one or a combination of the following: pressurizing the reservoir 201; functioning as an accumulator to dampen out pumping oscillations from the heat exchanger 204; and providing a start gas for starting up the propellant feed system.

In embodiments, a start gas may be another gas stored in a start gas reservoir (not shown). The start gas may be the gaseous propellant.

In embodiments, another pressurant reservoir (not shown) may be in communication with the reservoir 201 storing the liquid propellant in order to maintain pressure inside the reservoir 201. The other pressurant reservoir may include one or more devices (such as a flow control valve or a flow regulator utilizing pressure sensors) to pressurize the reservoir 201. In embodiments, the other pressurant reservoir may receive some of the gaseous propellant exiting the heat exchanger 204.

In an embodiment, the gaseous propellant exiting the heat exchanger 204 may pass through, or in the proximity of, one or more devices (not shown) that may contribute to regulating the gaseous propellant flow into the motive inlet of the jet pump 205 and the pressurant reservoir 207. As understood by a person skilled in the art, such device may function as a flow control valve, variable restriction flow device, or other such flow control device and may make use of one or more sensors, non-limiting examples of sensors may include pressure sensors, temperature sensors, flow sensors, for example for feedback and control of flow.

In an embodiment, the combustion chamber 202 may be in fluid communication with a propellant source 206 for receiving a second propellant. The propellant and the second propellant undergo a combustion reaction within the combustion chamber, resulting in propulsion.

In embodiments, for hybrid rocket engine applications, the propellant source 206 may be omitted and the combustion chamber 202 may store a solid propellant. In the combustion chamber 202, the mixed stream may combust with a quantity of a solid propellant contained in the combustion chamber 202, resulting in propulsion.

In embodiments, for monopropellant rocket engine applications, the propellant source 206 in FIG. 2 may be omitted. The combustion chamber 202 may receive a single propellant which may flow over, flow through, or otherwise interact with a catalyst, to undergo a reaction in the combustion chamber 202, resulting in propulsion.

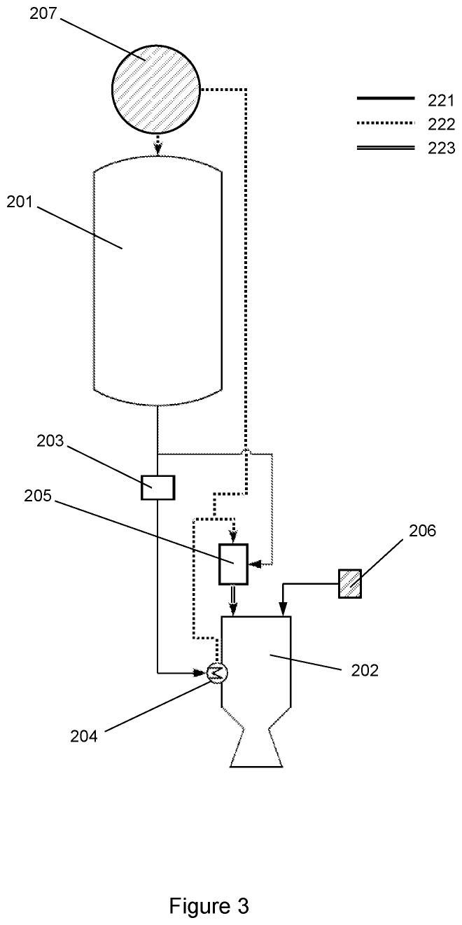

In an embodiment schematically illustrated in FIG. 3, a jet pump 205 receives a liquid propellant through a driven inlet and a gaseous propellant through a motive inlet. A mixed stream of the liquid propellant and the gaseous propellant is ejected from the jet pump 205 through an outlet. The mixed stream enters a combustion chamber 202.

The propellant in liquid state may follow a path illustrated in FIG. 3 by a solid line 221. The propellant in gaseous state may follow a path illustrated in FIG. 3 by a dotted line 222. The propellant in mixed stream state may follow a path illustrated in FIG. 3 by a double line 223.

A reservoir 201 may provide the liquid propellant for the driven inlet of the jet pump 205. The reservoir 201 may also provide the liquid propellant for a heat exchanger 204 via a pump 203.

In an embodiment, the liquid propellant exiting the reservoir 201 may pass through one or more devices that may contribute to regulating the liquid propellant flow into the driven inlet of the jet pump 205 and the pump 203. As understood by a person skilled in the art, such device may function as a flow control valve, variable restriction flow device, or other such flow control device and may make use of one or more sensors, non-limiting examples of sensors may include pressure sensors, temperature sensors, flow sensors.

The heat exchanger 204 is configured to transfer thermal energy from the adjacent combustion chamber 202 to a stream pumped into the heat exchanger 204 by the pump 203. In an embodiment, the stream may comprise the liquid propellant.

The transfer of thermal energy in the heat exchanger 204 transforms the stream (which may include the liquid propellant) pumped into the heat exchanger 204 by the pump 203 into the gaseous propellant. Some of the gaseous propellant exiting the heat exchanger 204 is fed into the motive inlet of the jet pump 205.

In an embodiment, some of the gaseous propellant exiting the heat exchanger 204 may be fed into a pressurant reservoir 207. The pressurant reservoir 207 storing the gaseous propellant may be in communication with the reservoir 201 storing the liquid propellant in order to maintain pressure inside the reservoir 201. In addition to or alternatively to maintaining pressure inside the reservoir 201, the pressurant reservoir 207 may function as an accumulator to dampen out pumping oscillations from the heat exchanger 204. In addition to or alternatively to maintaining pressure inside the reservoir 201 or functioning as an accumulator to dampen out pumping oscillations from the heat exchanger 204, the pressurant reservoir 207 may provide a start gas for starting up the propellant feed system.

The pressurant reservoir 207 may include one or more devices (such as a pump, a sensor, a gauge, a valve) which contribute to one or a combination of the following: pressurizing the reservoir 201; functioning as an accumulator to dampen out pumping oscillations from the heat exchanger 204; and providing a start gas for starting up the propellant feed system.

In embodiments, a start gas may be another gas stored in a start gas reservoir (not shown). The start gas may be the gaseous propellant.

In embodiments, another pressurant reservoir (not shown) may be in communication with the reservoir 201 storing the liquid propellant in order to maintain pressure inside the reservoir 201. The other pressurant reservoir may include one or more devices (such as a pump, a sensor, a gauge) to pressurize the reservoir 201. In embodiments, the other pressurant reservoir may receive some of the gaseous propellant exiting the heat exchanger 204.

In an embodiment, the gaseous propellant exiting the heat exchanger 204 may pass through one or more devices that may contribute to regulating the liquid propellant flow into the motive inlet of the jet pump 205 and the pressurant reservoir 207. As understood by a person skilled in the art, such device may function as a flow control valve, variable restriction flow device, or other such flow control device and may make use of one or more sensors, non-limiting examples of sensors may include pressure sensors, temperature sensors, flow sensors.

In an embodiment, the combustion chamber 202 may include a propellant source 206 for receiving another propellant.

In embodiments, for hybrid rocket engine applications, the propellant source 206 may be omitted and the combustion chamber 202 may store a solid propellant. In the combustion chamber 202, the mixed stream may combust with a quantity of a solid propellant contained in the combustion chamber 202, resulting in propulsion.

In embodiments, for monopropellant rocket engine applications, the propellant source 206 in FIG. 3 may be omitted. The combustion chamber 202 may receive a single propellant which may flow over, flow through, or otherwise interact with a catalyst, to undergo a reaction in the combustion chamber 202, resulting in propulsion.

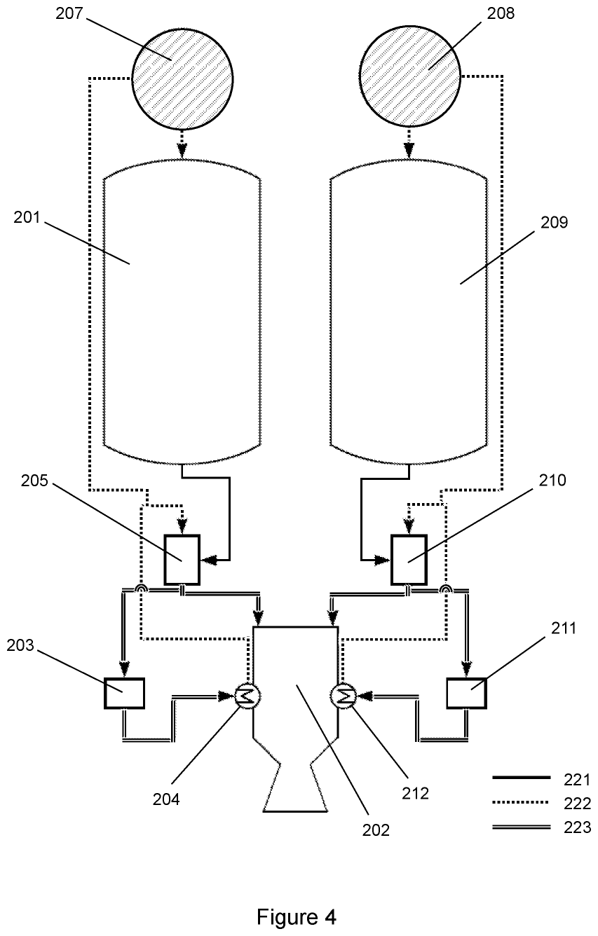

In an embodiment schematically illustrated in FIG. 4, the propellant feed system comprises as least the following elements and corresponding embodiments as discussed above with respect to FIG. 2: the jet pump 205, the liquid propellant, the gaseous propellant, the mixed stream, the combustion chamber 202, the heat exchanger 204, the pump 203, the reservoir 201, and the pressurant reservoir 207.

The embodiment schematically illustrated in FIG. 4 further comprises a second jet pump 210 that receives a second liquid propellant through a driven inlet and a second gaseous propellant through a motive inlet. A second mixed stream of the second liquid propellant and the second gaseous propellant is ejected from the second jet pump 210 through an outlet.

The propellant in liquid state may follow a path illustrated in FIG. 4 by a solid line 221. The propellant in gaseous state may follow a path illustrated in FIG. 4 by a dotted line 222. The propellant in mixed stream state may follow a path illustrated in FIG. 4 by a double line 223.

Some of the second mixed stream enters a combustion chamber 202. Some of the second mixed stream may enter a second pump 211 which pumps the second mixed stream into a second heat exchanger 212. In another embodiment, the second mixed stream ejected from the second jet pump 210 may pass through one or more devices that may contribute to regulating the second mixed stream flow into the combustion chamber 202 and the second pump 211. As understood by a person skilled in the art, such device may function as a flow control valve, variable restriction flow device, or other such flow control device, and may make use of one or more sensors, non-limiting examples of sensors may include pressure sensors, temperature sensors, flow sensors.

A second reservoir 209 may provide the second liquid propellant for the driven inlet of the second jet pump 210.

The second heat exchanger 212 is configured to transfer thermal energy from the adjacent combustion chamber 202 to a stream pumped into the second heat exchanger 212 by the second pump 211. In an embodiment, the stream may comprise the second mixed stream.

The transfer of thermal energy in the second heat exchanger 212 transforms the stream (which may include the second mixed stream) pumped into the second heat exchanger 212 by the second pump 211 into the second gaseous propellant. Some of the second gaseous propellant exiting the heat exchanger 212 is fed into the motive inlet of the second jet pump 210.

In embodiments, some of the second gaseous propellant exiting the second heat exchanger 212 may be fed into a second pressurant reservoir 208. The second pressurant reservoir 208 storing the second gaseous propellant may be in communication with the second reservoir 209 storing the second liquid propellant in order to maintain pressure inside the second reservoir 209. In addition to or alternatively to maintaining pressure inside the second reservoir 209, the second pressurant reservoir 208 may function as an accumulator to dampen out pumping oscillations from the second heat exchanger 212. In addition to or alternatively to maintaining pressure inside the second reservoir 209 or functioning as an accumulator to dampen out pumping oscillations from the second heat exchanger 212, the pressurant reservoir 208 may provide a second start gas for starting up the propellant feed system illustrated in FIG. 4.

In embodiments, the second gaseous propellant exiting the second heat exchanger 212 may pass through one or more devices that may contribute to regulating the second gaseous propellant flow into the motive inlet of the second jet pump 210 and the second pressurant reservoir 208. As understood by a person skilled in the art, such device may function as a flow control valve, variable restriction flow device, or other such flow control device and may make use of one or more sensors, non-limiting examples of sensors may include pressure sensors, temperature sensors, flow sensors.

In embodiments, the second pressurant reservoir 208 may include one or more devices (e.g., a pump, a sensor, a gauge, a valve) which contribute to one or a combination of the following: pressurizing the second reservoir 209; functioning as an accumulator to dampen out pumping oscillations from the second heat exchanger 212; and providing a second start gas for starting up the propellant feed system.

In embodiments, a second start gas may be another gas stored in a second start gas reservoir (not shown). The second start gas may be the second gaseous propellant.

In embodiments, another second pressurant reservoir (not shown) may be in communication with the second reservoir 209 storing the second liquid propellant in order to maintain pressure inside the second reservoir 209. The other second pressurant reservoir may include one or more devices (such as a pump, a sensor, a gauge) to pressurize the second reservoir 209. In embodiments, the other second pressurant reservoir may receive some of the second gaseous propellant exiting the second heat exchanger 212.

In embodiments, the second gaseous propellant exiting the second heat exchanger 212 may pass through one or more devices that may contribute to regulating the second liquid propellant flow into the motive inlet of the second jet pump 210 and the second pressurant reservoir 208. As understood by a person skilled in the art, such device may function as a flow control valve, variable restriction flow device, or other such flow control device and may make use of one or more sensors, non-limiting examples of sensors may include pressure sensors, temperature sensors, flow sensors.

In embodiments, some or all of the components and connections of the propellant feed system illustrated in FIG. 4 and corresponding to the liquid propellant, the gaseous propellant, and the mixed stream, may include some or all of embodiments schematically illustrated in either FIG. 2 or FIG. 3, or combinations thereof.

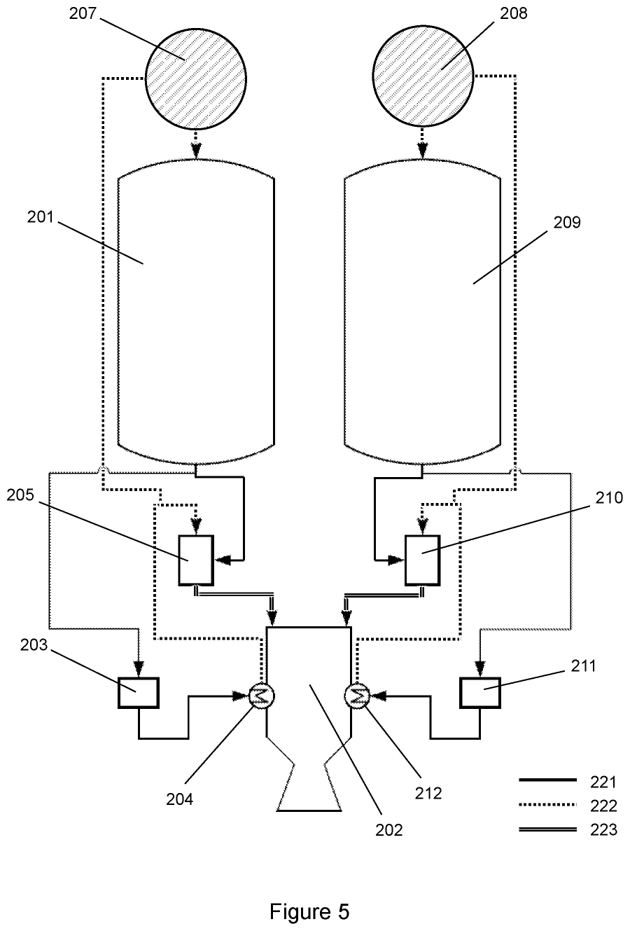

In an embodiment schematically illustrated in FIG. 5, the propellant feed system comprises as least the following elements as discussed above with respect to FIG. 3: the jet pump 205, the liquid propellant, the gaseous propellant, the mixed stream, the combustion chamber 202, the heat exchanger 204, the pump 203, the reservoir 201, and the pressurant reservoir 207.

The embodiment schematically illustrated in FIG. 5 further comprises a second jet pump 210 that receives a second liquid propellant through a driven inlet and a second gaseous propellant through a motive inlet. A second mixed stream of the second liquid propellant and the second gaseous propellant is ejected from the second jet pump 210 through an outlet.

The propellant in liquid state may follow a path illustrated in FIG. 5 by a solid line 221. The propellant in gaseous state may follow a path illustrated in FIG. 5 by a dotted line 222. The propellant in mixed stream state may follow a path illustrated in FIG. 5 by a double line 223.

A second reservoir 209 may provide the second liquid propellant for the driven inlet of the second jet pump 210. The second reservoir 209 may also provide the second liquid propellant for a second heat exchanger 212 via a second pump 211.

In embodiments, the second liquid propellant exiting the second reservoir 209 may pass through one or more devices that may contribute to regulating the second liquid propellant flow into the driven inlet of the second jet pump 210 and the second pump 211. As understood by a person skilled in the art, such device may function as a flow control valve, variable restriction flow device, or other such flow control device and may make use of one or more sensors, non-limiting examples of sensors may include pressure sensors, temperature sensors, flow sensors.

The second heat exchanger 212 is configured to transfer thermal energy from the adjacent combustion chamber 202 to a stream pumped into the second heat exchanger 212 by the second pump 211. In an embodiment, the stream may comprise the second liquid propellant.

The transfer of thermal energy in the second heat exchanger 212 transforms the stream (which may include the second liquid propellant) pumped into the second heat exchanger 212 by the second pump 211 into the second gaseous propellant. Some of the second gaseous propellant exiting the second heat exchanger 212 is fed into the motive inlet of the second jet pump 210.

In embodiments, some of the second gaseous propellant exiting the second heat exchanger 212 may be fed into a second pressurant reservoir 208. The second pressurant reservoir 208 storing the second gaseous propellant may be in communication with the second reservoir 209 storing the second liquid propellant in order to maintain pressure inside the second reservoir 209. In addition to or alternatively to maintaining pressure inside the second reservoir 209, the second pressurant reservoir 208 may function as an accumulator to dampen out pumping oscillations from the second heat exchanger 212. In addition to or alternatively to maintaining pressure inside the second reservoir 209 or functioning as an accumulator to dampen out pumping oscillations from the second heat exchanger 212, the second pressurant reservoir 208 may provide a second start gas for starting up the propellant feed system illustrated in FIG. 5.

In embodiments, a second start gas may be another gas stored in a second start gas reservoir (not shown). The second start gas may be the second gaseous propellant.

In embodiments, another second pressurant reservoir (not shown) may be in communication with the second reservoir 209 storing the second liquid propellant in order to maintain pressure inside the second reservoir 209. The other second pressurant reservoir may include one or more devices (such as a pump, a sensor, a gauge) to pressurize the second reservoir 209. In embodiments, the other second pressurant reservoir may receive some of the second gaseous propellant exiting the second heat exchanger 212.

In embodiments, the second gaseous propellant exiting the second heat exchanger 212 may pass through one or more devices that may contribute to regulating the second gaseous propellant flow into the motive inlet of the second jet pump 210 and the second pressurant reservoir 208. As understood by a person skilled in the art, such device may function as a flow control valve, variable restriction flow device, or other such flow control device, and may make use of one or more sensors, non-limiting examples of sensors may include pressure sensors, temperature sensors, flow sensors.

In embodiments, some or all of the components and connections of the propellant feed system illustrated in FIG. 5 and corresponding to the liquid propellant, the gaseous propellant, and the mixed stream, may include some or all of embodiments schematically illustrated in either FIG. 2 or FIG. 3, or combinations thereof.

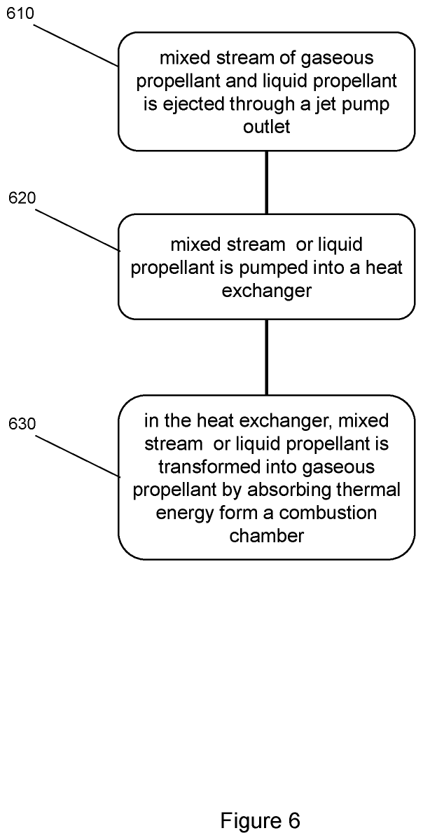

In an embodiment schematically illustrated in FIG. 6, the method of operating the propellant feed system of the present disclosure includes a step 610 of ejecting a mixed stream of a liquid propellant and a gaseous propellant from a jet pump. The method further includes a step 620 of a heat exchanger receiving one of the mixed stream, the liquid propellant, or a combination thereof. In the heat exchanger, a further step 630 includes transforming the mixed stream, the liquid propellant or a combination thereof into a gaseous propellant by transferring thermal energy form a combustion chamber to the mixed stream, the liquid propellant or a combination thereof.

The method illustrated in FIG. 6 is common to various embodiments of the propellant feed system of the present disclosure.

The method illustrated in FIG. 6 applies to steady state operation of the propellant feed system.

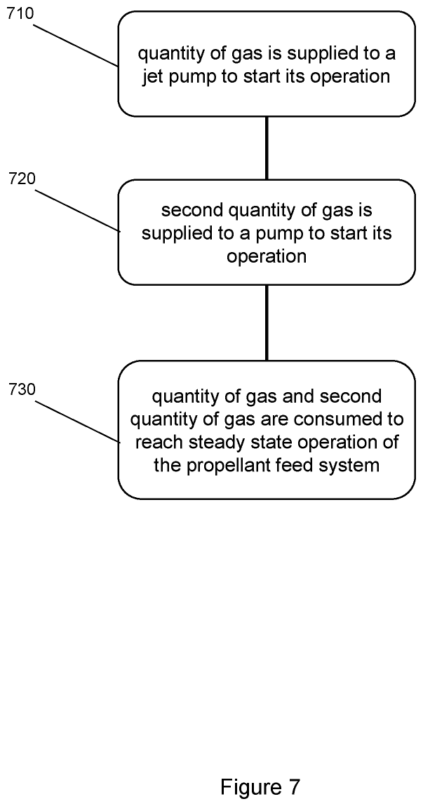

In an embodiment schematically illustrated in FIG. 7, a method of starting up the propellant feed system of the present disclosure includes a step 710 of supplying a quantity of start gas to the motive inlet of the jet pump (e.g., jet pump 205 in FIG. 2 or FIG. 3). Another step 720 includes supplying a second quantity of start gas to the pump (e.g., pump 203 in FIG. 2 or FIG. 3) that supplies a stream to the heat exchanger (e.g., heat exchanger 204 in FIG. 2 or FIG. 3). Another step 730 includes using the supplied quantity and the supplied second quantity to operate the propellant feed system until the propellant feed system reaches a steady state of operation.

The steady state of operation of the propellant feed system may be determined, for example, using a sensor or various sensors. Such sensor or sensors may include devices that measure temperature, pressure, flow rate and other relevant parameters as understood by a person skilled in the art. The steady-state condition can be assessed, for example, by ensuring the operation of the rocket engine is not varying over time, the amount of time may be pre-determined, for example; or is varying within a given range, the range may be pre-determined, for example.

Once the steady state of operation of the propellant feed system is reached, the supply of start gas to the jet pump and the pump is halted. The propellant feed system continues to operate in accordance with various embodiments of the present disclosure.

For various embodiments of the propellant feed system for a bipropellant rocket, such as those discussed previously and illustrated in FIGS. 4 and 5, the start gas and a second start gas may be used to start up the operation of the corresponding propellant feed system components for a bipropellant rocket until a steady state of operation is reached.

The method of starting up a propellant feed system within a bipropellant rocket may include a step 710 of supplying a quantity of a start gas to the motive inlet of the jet pump (e.g., jet pump 205 in FIG. 4 or FIG. 5) and a quantity of a second start gas to the motive inlet of the second jet pump (e.g., second jet pump 210 in FIG. 4 or FIG. 5). Another step 720 includes supplying a second quantity of the start gas to the pump (e.g., pump 203 in FIG. 4 or FIG. 5) that supplies a stream to the heat exchanger (e.g. heat exchanger 204 in FIG. 4 or FIG. 5), and supplying a second quantity of the second start gas to the second pump (e.g. pump 211 in FIG. 4 or FIG. 5) that supplies a stream to the second heat exchanger (e.g. heat exchanger 212 in FIG. 4 or FIG. 5). Another step 730 includes using the supplied quantities of the start gas and the second start gas and the second quantities of the start gas and the second start gas to operate the propellant feed system within a bipropellant rocket until the propellant feed system reaches a steady state of operation.

The start gas may include the gaseous propellant, as discussed previously with respect to various embodiments of FIGS. 2, 3, 4 and 5. The start gas may be stored in the pressurant reservoir 207. The start gas may be stored in another reservoir (not shown). In a preferred embodiment, the start gas is the gaseous propellant.

The second start gas may include the second gaseous propellant, as discussed previously with respect to various embodiments of FIGS. 4 and 5. The second start gas may be stored in the second pressurant reservoir 208. The second start gas may be stored in another reservoir (not shown). In a preferred embodiment, the second start gas is the second gaseous propellant.

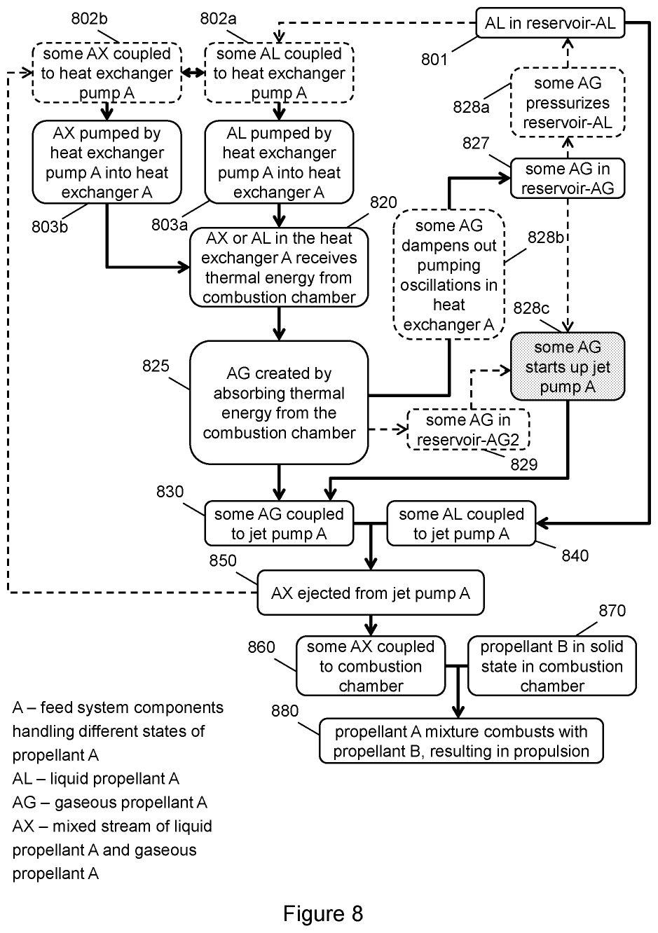

In an embodiment schematically illustrated in FIG. 8, a detailed example method of operating the propellant feed system for a hybrid rocket of the present disclosure is shown.

The propellant feed system may be started by supplying a start gas as discussed previously with respect to FIG. 6. The start gas may be the gaseous propellant. The start gas may be sourced from the pressurant reservoir, as shown in step 827. Some of the gaseous propellant in the pressurant reservoir may be used as the start gas and supplied to the jet pump to start its operation, as shown in step 828c. Either in addition or alternatively, the start gas may be stored in another reservoir which may receive some of the gaseous propellant from the heat exchanger, as shown in step 829. Some of the gaseous propellant in the pressurant reservoir may be used to pressurize the liquid propellant reservoir, as shown in step 828a. The pressurant reservoir may be used as an accumulator dampening out pumping oscillations from the heat exchanger, as shown in step 828b.

Once the propellant feed system reaches steady state operation, as discussed previously with respect to FIG. 6, the jet pump operation may continue using the gaseous propellant from the heat exchanger instead of the start gas from the pressurant tank, as shown in step 830.

As shown in step 840, the liquid propellant is supplied to the jet pump from the reservoir. The reservoir stores the liquid propellant, as shown in step 801.

The reservoir may also supply some of the liquid propellant to a pump, as shown in step 802a. The pump pumps the stream that it receives (the liquid propellant) into the heat exchanger, as shown in step 803a.

In the heat exchanger, the liquid propellant receives thermal energy from the combustion chamber, as shown in step 820. The thermal energy transforms the liquid propellant in the heat exchanger into the gaseous propellant, as shown in step 825. At least some of the gaseous propellant is coupled to the motive inlet of the jet pump, as shown in step 830.

In the jet pump, the liquid propellant and the gaseous propellant combine into a mixed stream which is ejected through an outlet of the jet pump, as shown in step 850.

Some of the mixed stream ejected from the jet pump may be coupled to the pump, as shown in step 802b either alternatively to or in combination with step 802a discussed previously. The pump pumps the stream that it receives (the mixed stream) into the heat exchanger, as shown in step 803b either alternatively to or in combination with step 803a. In the heat exchanger, the mixed stream receives thermal energy from the combustion chamber, as shown in step 820. The thermal energy transforms the mixed stream in the heat exchanger into the gaseous propellant, as shown in step 825.

In step 870, a solid propellant is stored in the combustion chamber.

The mixed stream ejected from the jet pump and coupled to the combustion chamber in step 860, combusts with the solid propellant that is stored in the combustion chamber, generating propulsion, as shown in step 880.

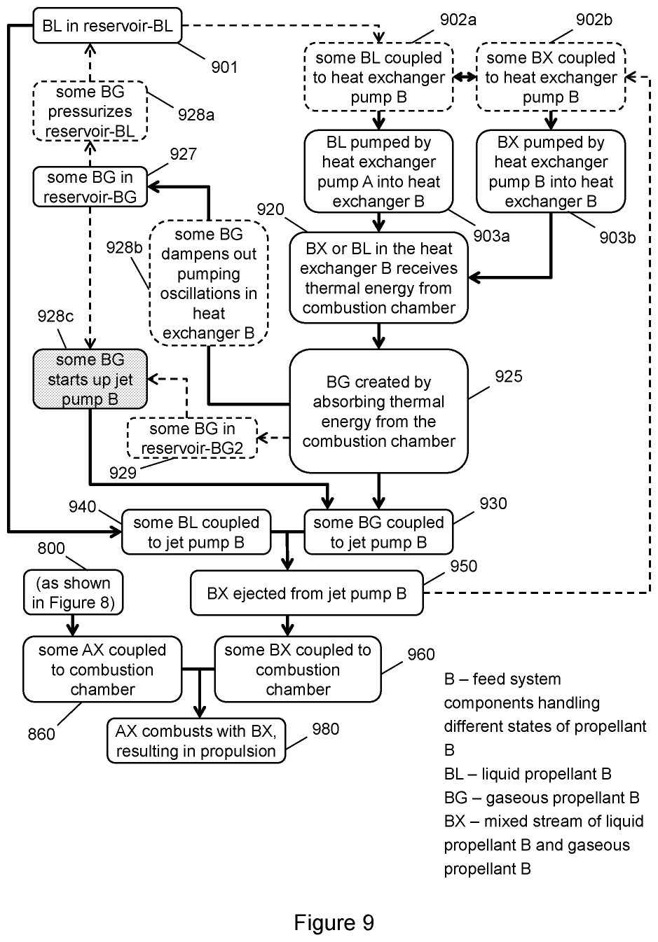

In an embodiment schematically illustrated in FIG. 9, a detailed example method of operating the propellant feed system for a bipropellant rocket of the present disclosure is shown.

The propellant feed system for a bipropellant rocket may be started by supplying a start gas and a second start gas as discussed previously with respect to FIG. 6. The start gas may be the gaseous propellant. The second start gas may be the second gaseous propellant.

The start gas may be sourced from the pressurant reservoir, as shown in step 827 of FIG. 8. Some of the gaseous propellant in the pressurant reservoir may be used as the start gas and supplied to the jet pump to start its operation, as shown in step 828c of FIG. 8. Either in addition or alternatively, the start gas may be stored in another reservoir which may receive some of the gaseous propellant from the heat exchanger, as shown in step 829 of FIG. 8. Some of the gaseous propellant in the pressurant reservoir may be used to pressurize the liquid propellant reservoir, as shown in step 828a of FIG. 8. The pressurant reservoir may be used as an accumulator dampening out pumping oscillations from the heat exchanger, as shown in step 828b of FIG. 8.

The second start gas may be sourced from the second pressurant reservoir, as shown in step 927 of FIG. 9. Some of the second gaseous propellant in the second pressurant reservoir may be used as the second start gas and supplied to the second jet pump to start its operation, as shown in step 928c of FIG. 9. Either in addition or alternatively, the second start gas may be stored in another second reservoir which may receive some of the second gaseous propellant from the second heat exchanger, as shown in step 929 of FIG. 9. Some of the second gaseous propellant in the second pressurant reservoir may be used to pressurize the second liquid propellant reservoir, as shown in step 928a of FIG. 9. The second pressurant reservoir may be used as an accumulator dampening out pumping oscillations from the second heat exchanger, as shown in step 928b of FIG. 9.

Once the propellant feed system for a bipropellant rocket reaches steady state operation, as discussed previously with respect to FIG. 6, the jet pump operation may continue using the gaseous propellant from the heat exchanger instead of the start gas from the pressurant tank, as shown in step 830 of FIG. 8; and the second jet pump operation may continue using the second gaseous propellant from the second heat exchanger instead of the second start gas from the second pressurant tank, as shown in step 930 of FIG. 9.

As shown in step 840 of FIG. 8, the liquid propellant is supplied to the jet pump from the reservoir. The reservoir stores the liquid propellant, as shown in step 801 of FIG. 8. The reservoir may also supply some of the liquid propellant to a pump, as shown in step 802a of FIG. 8. The pump pumps the stream that it receives (the liquid propellant) into the heat exchanger, as shown in step 803a of FIG. 8.

Similarly with respect to the second liquid propellant, as shown in step 940 of FIG. 9, the second liquid propellant is supplied to the second jet pump from the second reservoir. The second reservoir stores the second liquid propellant, as shown in step 901 of FIG. 9. The second reservoir may also supply some of the second liquid propellant to a second pump, as shown in step 902a of FIG. 9. The second pump pumps the stream that it receives (the second liquid propellant) into the second heat exchanger, as shown in step 903a of FIG. 9.

In the heat exchanger, the liquid propellant receives thermal energy from the combustion chamber, as shown in step 820 of FIG. 8. The thermal energy transforms the liquid propellant in the heat exchanger into the gaseous propellant, as shown in step 825 of FIG. 8. At least some of the gaseous propellant is coupled to the motive inlet of the jet pump, as shown in step 830 of FIG. 8.

Similarly, in the second heat exchanger, the second liquid propellant receives thermal energy from the combustion chamber, as shown in step 920 of FIG. 9. The thermal energy transforms the second liquid propellant in the second heat exchanger into the second gaseous propellant, as shown in step 925 of FIG. 9. At least some of the second gaseous propellant is coupled to the motive inlet of the second jet pump, as shown in step 930 of FIG. 9.

In the jet pump, the liquid propellant and the gaseous propellant combine into a mixed stream which is ejected through an outlet of the jet pump, as shown in step 850 of FIG. 8.

Similarly, in the second jet pump, the second liquid propellant and the second gaseous propellant combine into a second mixed stream which is ejected through an outlet of the second jet pump, as shown in step 950 of FIG. 9.

Some of the mixed stream ejected from the jet pump may be coupled to the pump, as shown in step 802b of FIG. 8 either alternatively to or in combination with step 802a of FIG. 8 discussed previously. The pump pumps the stream that it receives (the mixed stream) into the heat exchanger, as shown in step 803b of FIG. 8 either alternatively to or in combination with step 803a of FIG. 8. In the heat exchanger, the mixed stream receives thermal energy from the combustion chamber, as shown in step 820 of FIG. 8. The thermal energy transforms the mixed stream in the heat exchanger into the gaseous propellant, as shown in step 825 of FIG. 8.

Similarly, some of the second mixed stream ejected from the second jet pump may be coupled to the second pump, as shown in step 902b of FIG. 9 either alternatively to or in combination with step 902a of FIG. 9 discussed previously. The second pump pumps the stream that it receives (the second mixed stream) into the second heat exchanger, as shown in step 903b of FIG. 9 either alternatively to or in combination with step 903a of FIG. 9. In the second heat exchanger, the second mixed stream receives thermal energy from the combustion chamber, as shown in step 920 of FIG. 9. The thermal energy transforms the second mixed stream in the second heat exchanger into the second gaseous propellant, as shown in step 925 of FIG. 9.

The combustion chamber receives the mixed stream ejected from the jet pump and in step 860 in FIG. 9. The combustion chamber also receives the second mixed stream ejected from the second jet pump and in step 960 in FIG. 9. In step 980, the mixed stream and the second mixed stream react combustively to generate propulsion.

Although the present disclosure has been described with reference to certain specific embodiments, various modifications thereof will be apparent to those skilled in the art without departing from the spirit and scope of the present disclosure. All such modifications as would be apparent to one skilled in the art are intended to be included within the scope of the following claims.

We claim:

1. A propellant feed system for a rocket engine comprising:
a jet pump including a motive inlet for receiving a gaseous propellant, a driven inlet for receiving a liquid propellant, and an outlet for ejecting a mixed stream of the gaseous propellant and the liquid propellant into a combustion chamber;
a heat exchanger configured to transfer thermal energy from the combustion chamber to the liquid propellant or the mixed stream, thereby transforming the liquid propellant or the mixed stream into the gaseous propellant; and
a pump configured to pump the liquid propellant or the mixed stream into the heat exchanger.

2. The propellant feed system of claim 1, further comprising a reservoir storing the liquid propellant, an outlet of the reservoir providing the liquid propellant to the jet pump.

3. The propellant feed system of claim 2, further comprising a pressurant reservoir storing a pressure gas to apply pressure to the reservoir.

4. The propellant feed system of claim 3, wherein the pressure gas comprises the gaseous propellant, the gaseous propellant being received from the heat exchanger.

5. The propellant feed system of claim 1, wherein the jet pump comprises a plurality of jet pumps connected in series, a plurality of jet pumps connected in parallel, or a plurality of jet pumps connected in both series and parallel.

6. The propellant feed system of claim 1, wherein the combustion chamber receives the mixed stream from the jet pump outlet.

7. The propellant feed system of claim 6, wherein the combustion chamber comprises a propellant source for receiving another propellant, the other propellant and the mixed stream being combusted within the combustion chamber.

8. The propellant feed system of claim 6, wherein the mixed stream is combusted within the combustion chamber with a solid propellant contained in the combustion chamber.

9. The propellant feed system of claim 7, wherein the propellant source comprises:
a second jet pump including a second motive inlet for receiving a second gaseous propellant, a second driven inlet for receiving a second liquid propellant, and a second outlet for ejecting a second mixed stream of the second gaseous propellant and the second liquid propellant;
a second heat exchanger configured to transfer thermal energy from the combustion chamber to the second liquid propellant or the second mixed stream, thereby transforming the second liquid propellant or the second mixed stream into the second gaseous propellant; and
a second pump configured to pump the second liquid propellant or the second mixed stream into the second heat exchanger.

10. A method for operating a rocket engine, the method comprising:
a jet pump receiving a gaseous propellant through a motive inlet, receiving a liquid propellant through a driven inlet, and ejecting a mixed stream of the gaseous propellant and the liquid propellant through an outlet;
a heat exchanger receiving the liquid propellant or the mixed stream, transferring thermal energy from a combustion chamber to the liquid propellant or the mixed stream, thereby transforming the liquid propellant or the mixed stream into the gaseous propellant; and
a pump pumping the liquid propellant or the mixed stream into the heat exchanger.

11. The method of claim 10, further comprising a reservoir storing the liquid propellant, an outlet of the reservoir providing the liquid propellant to the jet pump.

12. The method of claim 11, further comprising a pressurant reservoir storing a pressure gas to apply pressure to the reservoir.

13. The method of claim 12, wherein the pressure gas comprises the gaseous propellant, the gaseous propellant being received from the heat exchanger.

14. The method of claim 10, wherein the combustion chamber receives the mixed stream from the jet pump outlet.

15. The method of claim 14, wherein the combustion chamber comprises a propellant source for receiving another propellant, the other propellant and the mixed stream being combusted within the combustion chamber.

16. The method of claim 14, wherein the mixed stream is combusted within the combustion chamber with a solid propellant contained in the combustion chamber.

17. The method of claim 10, further comprising:
a second jet pump receiving a second gaseous propellant through a second motive inlet, receiving a second liquid propellant through a second driven inlet, and ejecting a second mixed stream of the second gaseous propellant and the second liquid propellant through a second outlet;
a second heat exchanger receiving the second liquid propellant or the second mixed stream, transferring thermal energy from the combustion chamber to the second liquid propellant or the second mixed stream, thereby transforming the second liquid propellant or the second mixed stream into the second gaseous propellant; and
a second pump pumping the second liquid propellant or the second mixed stream into the second heat exchanger.

18. The method of claim 17, wherein the combustion chamber receives the mixed stream from the jet pump outlet and the second mixed stream from the second jet pump outlet.

19. The method for starting operation of the propellant feed system of claim 1 comprising:
supplying a quantity of a gas to the jet pump;
supplying a second quantity of the gas to the pump;
wherein the quantity of the gas and the second quantity of the gas is sufficient in amount to result in steady state operation of the propellant feed system.

20. The method for starting operation of the propellant feed system of claim 9, the method comprising:
supplying a quantity of a gas to the jet pump;
supplying a second quantity of the gas to the pump;
supplying a quantity of a second gas to the second jet pump;
supplying a second quantity of the second gas to the second pump;
wherein the quantity of the gas, the second quantity of the gas, the quantity of the second gas, and the second quantity of the second gas is sufficient in amount to result in steady state operation of the propellant feed system.
